(19) United States
(12) Patent Application Publication
(10) Pub. No.: US 2012/0002246 A1
(43) Pub. Date: Jan. 5, 2012

(54) IMAGE READING APPARATUS, IMAGE FORMING APPARATUS, AND SIZE DETECTING METHOD

(75) Inventors: Hiroyuki SHIRAISHI, Shizuoka-ken (JP); Naoya Koseki, Shizuoka-ken (JP); Sueo Ueno, Shizuoka-ken (JP); Katsuya Nagamochi, Tokyo (JP); Yusuke Hashizume, Chiba-ken (JP); Koji Shimokawa, Shizuoka-ken (JP); Mitsuru Hatano, Kanagawa-ken (JP)

(73) Assignees: Toshiba Tec Kabushiki Kaisha, Tokyo (JP); Kabushiki Kaisha Toshiba, Tokyo (JP)

(21) Appl. No.: 13/174,609

(22) Filed: Jun. 30, 2011

Related U.S. Application Data
(60) Provisional application No. 61/361,352, filed on Jul. 2, 2010.
(60) Provisional application No. 61/361,355, filed on Jul. 2, 2010.

(51) Int. Cl. H04N 1/04

(52) U.S. Cl. 358/475

(57) ABSTRACT

According to an embodiment, an image reading apparatus includes: a light emitting body configured to emit light at illuminance lower than illuminance in reading an original document; a sensor configured to detect opening and closing of a cover; an image pickup element configured to pick up an image of the original document, on which the light from the light emitting body is irradiated, if the cover is open; and a control and determining section configured to turn on the light emitting body if the cover is opened and specify a pixel having a value exceeding a threshold from the picked-up image to determine the size of the original document.

### CROSS-REFERENCE TO RELATED APPLICATIONS

This application is based upon and claims the benefit of priority from: U.S. provisional application 61/361,352, filed on Jul. 2, 2010; U.S. provisional application 61/361,355, filed on Jul. 2, 2010; the entire contents all of which are incorporated herein by reference.

### FIELD

Embodiments described herein relate generally to a technique for determining the size of an original document.

### BACKGROUND

As a method of detecting a document size in a main scanning direction of an image forming apparatus, there is known a method of turning on an exposure lamp, which is a reading light source, mounted on a carriage and capturing light reflected on a document surface into a CCD sensor to thereby detect a size. As another method of detecting the size of an original document placed on a document table, a reflective photosensor (hereinafter referred to as APS sensor) is used.

In the method of using the exposure lamp, since the illuminance of the exposure lamp is high, if the exposure lamp is always kept on from the time when a user sets an original document, user's eyes are hurt. Therefore, the image forming apparatus in the past turns on the exposure lamp and decides a document size if a cover for pressing an original document from above (hereinafter referred to as platen cover) is closed or if a copy start button is pressed. In this case, the document size is not recognized until the platen cover is closed or the copy start button is pressed. The exposure lamp for reading consumes large power.

If an original document is detected by the method of using the ASP sensor, plural APS sensors are necessary to determine a longitudinal size and a lateral size of the original document. Since the APS sensor includes a light emitting element and a light receiving element, power consumption of one APS sensor is as large as 150 mA to 200 mA.

### DESCRIPTION OF THE DRAWINGS

FIG. 1 is a diagram of a configuration example of an image forming apparatus according to a first embodiment;

FIG. 2 is a diagram of a hardware configuration example of a scanning optical system according to the first embodiment;

FIG. 3 is a schematic plan view of an example of arrangement of an original document in an image reading section according to the first embodiment;

FIG. 4 is a block diagram of a main configuration example of the image reading section according to the first embodiment;

FIG. 5 is a graph of an example of a luminance value in detecting, with a CCD sensor, a main scanning direction size of the original document shown in FIG. 3;

FIG. 6 is a flowchart for explaining an operation example of the image reading section according to the first embodiment;

FIG. 7A is a time chart of power on and off performed if a platen cover is closed in the first embodiment;

FIG. 7B is a time chart of power on and off performed if a copy start button is pressed in the first embodiment;

FIG. 8 is a flowchart for explaining an operation example of an image reading section according to a second embodiment;

FIG. 9A is a time chart of power on and off performed if a platen cover is closed in the second embodiment; and

FIG. 9B is a time chart of power on and off performed if a copy start button is pressed in the second embodiment.

### DETAILED DESCRIPTION

In general, according to an embodiment, an image reading apparatus includes: a light emitting body configured to emit light at illuminance lower than illuminance in reading an original document; a sensor configured to detect opening and closing of a cover for pressing, from above, an original document arranged on a document table; an image pickup element configured to pickup an image of the original document, which is arranged on the document table and on which the light from the light emitting body is irradiated, if the sensor detects that the cover is opened; and a control and determining section configured to turn on, if the sensor detects that the cover is opened, a power supply for the light emitting body and specify a pixel having a value exceeding a threshold from the image picked up by the image pickup element to determine the size of the original document arranged on the document table.

An image forming apparatus according to the embodiment includes an image reading section equivalent to the image reading apparatus. In the image reading section, an LED (Light Emitting Diode) is attached to the outside of a carriage (in the embodiment, provided in a document scale). The image reading section reflects light from the LED with a reflector and irradiates reflected light from the reflector on a document surface. The light reflected on the document surface is made incident on a CCD sensor, whereby the image reading section detects a document size in a main scanning direction. Alight source maybe an ultraviolet LED, light of which is hardly seen.

The LED consumes small power and has low illuminance because indirect light (the reflected light from the reflector) is irradiated on the document table. Therefore, even if the LED is turned on if a platen cover is open, a burden on user's eyes can be reduced. The user can always recognize a document size.

Embodiments are explained below with reference to the accompanying drawings.

### First Embodiment

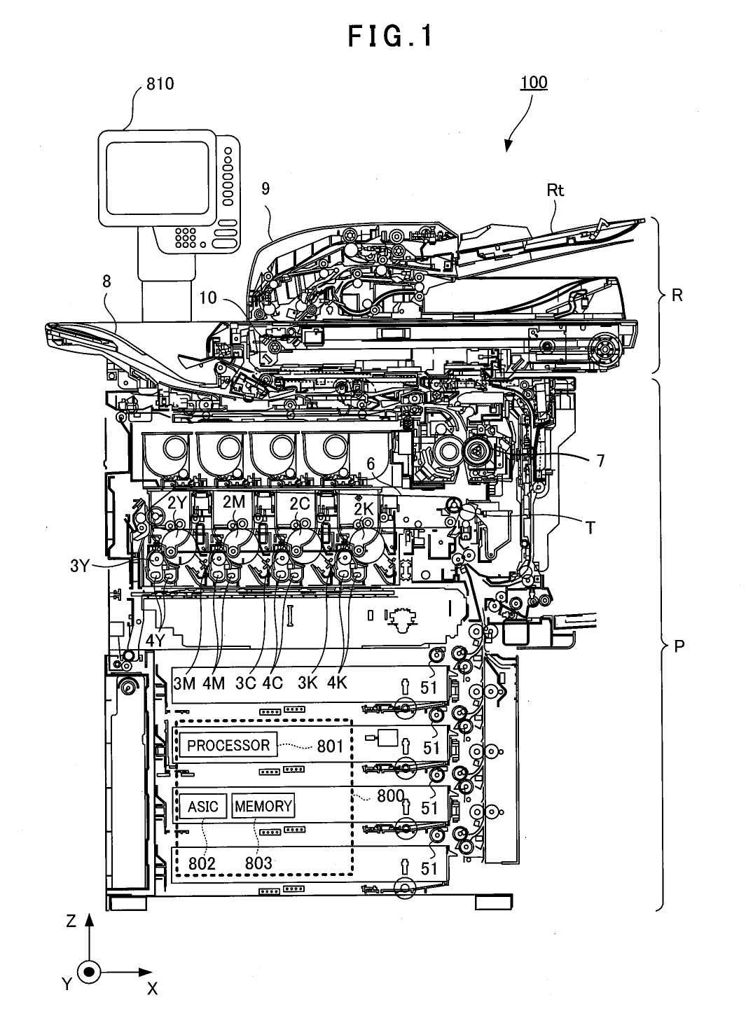

FIG. 1 is a longitudinal sectional view of a schematic configuration of an image forming apparatus (an MFP: Multi Function Peripheral) according to a first embodiment. As shown in FIG. 1, an image forming apparatus 100 according to this embodiment includes an image reading section R (an image reading apparatus) and an image forming section P.

The image reading section R has a function of scanning and reading images of a sheet document and a book document. The image reading section R includes a scanning optical system 10 including plural reflection mirrors and a CCD sensor, which is an image pickup element, and includes an auto document feeder (ADF) 9 configured to be capable of automatically feeding an original document to a predetermined placing position. Images of an original document placed on a document tray Rt and automatically fed by the auto document feeder 9 and an original document placed on a document table are read by the scanning optical system 10.

The image forming section P has a function of forming a developer image on a sheet on the basis of, for example, an image read from an original document by the image reading section R or image data transmitted from an external apparatus to the image forming apparatus 100. The image forming section P includes photoconductive members 2Y to 2K, developing rollers 3Y to 3K, mixers 4Y to 4K, an intermediate transfer belt 6, a fixing device 7, and a discharge tray 8.

The image forming apparatus 100 includes a control board 800. The control board 800 includes a processor 801, which is an arithmetic processing device (e.g., a CPU (Central Processing Unit) or an MPU (Micro Processing Unit)), an ASIC (Application Specific Integrated Circuit) 802, and a memory 803, which is an aggregate of a nonvolatile storage device and a volatile storage device. The processor 801 has a role of performing various kinds of processing in the image forming apparatus 100 and also has a role of realizing various functions by loading a computer program stored in advance in a nonvolatile storage area of the memory 803 to a volatile storage area and executing the loaded computer program. The memory 803 can include an SRAM (Static Random Access Memory), a DRAM (Dynamic Random Access Memory), a VRAM (Video RAM), a flash ROM (Read Only Memory), a hard disk drive or the like. The memory 803 has a role of storing various kinds of information and computer programs used in the image forming apparatus 100.

The image forming apparatus 100 includes a control panel 810. The control panel 810 receives an instruction from a user and displays processing contents to the user.

An overview of copy processing is explained below as an example of processing in the image forming apparatus 100 according to this embodiment.

First, a sheet picked up by a pickup roller 51 is fed into a sheet conveying path. The sheet fed into the sheet conveying path is conveyed in a predetermined conveying direction by plural roller pairs.

Images of plural sheet documents continuously automatically fed by the auto document feeder 9 are read by the scanning optical system 10.

The control board 800 applies predetermined image processing to image data read from the original documents by the image reading section R. Thereafter, electrostatic latent images of data after the image processing are formed on photoconductive surfaces of photoconductive members 2Y, 2M, 2C, and 2K for transferring developer images of Y (yellow), M (magenta), C (cyan), and B (black) onto the sheet.

Subsequently, developers agitated by the mixers 4Y to 4K in a developing device are supplied to the photoconductive members 2Y to 2K, on which the electrostatic latent images are formed as explained above, by the developing rollers (so-called magnet rollers) 3Y to 3K. Consequently, the electrostatic latent images formed on the photoconductive surfaces of the photoconductive members are visualized.

Developer images formed on the photoconductive drums in this way are transferred onto the belt surface of the intermediate transfer belt 6 (so-called primary transfer). The developer images carried by the rotation of the intermediate transfer belt 6 are transferred onto conveyed sheets in a predetermined secondary transfer position T.

The developer images transferred onto the sheets are heated and fixed on the sheets by the fixing device 7. The sheets having the developer images heated and fixed thereon are conveyed through a conveying path by plural conveying roller pairs and sequentially discharged onto the discharge tray 8.

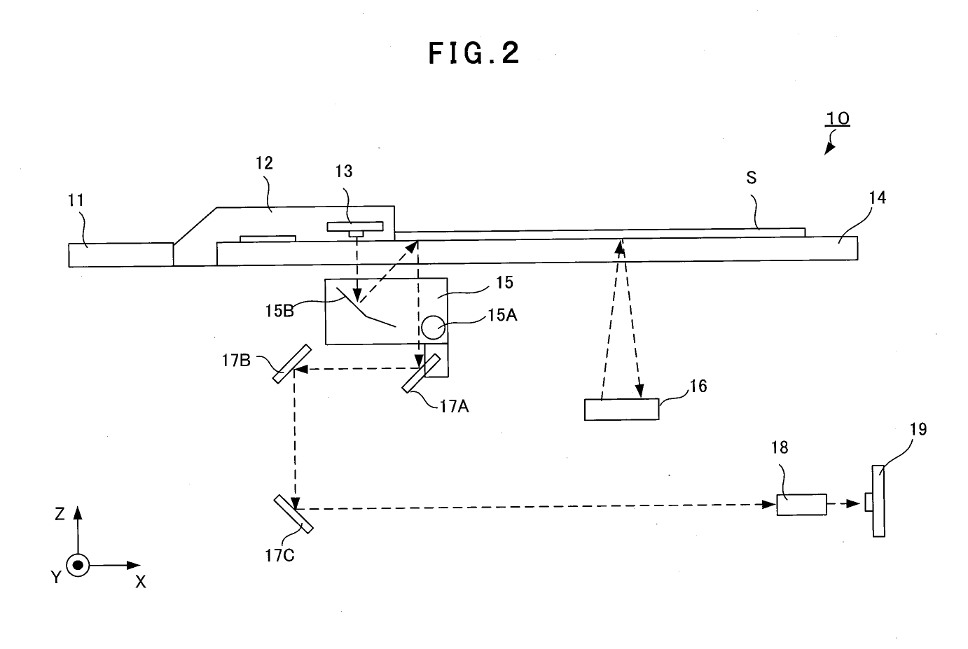

A configuration example of the scanning optical system 10 is explained with reference to FIG. 2. The scanning optical system 10 includes a through read glass 11, which is a small window, for reading an original document fed by the auto document feeder 9, and a document table glass 14 on which an original document S is placed by the user. The scanning optical system 10 includes a document scale 12 that is arranged around the document table glass 14 and on which any one or both of scales and standard sizes for the user to check a document size are inscribed. The document scale 12 includes an LED array 13 configured to emit light downward in a Z axis direction. The LED array 13 includes plural LED elements and emits light at illuminance lower than illuminance in reading the original document (at illuminance lower than the illuminance of an exposure lamp 15A in the past).

The scanning optical system 10 includes a carriage 15, which is a moving body, configured to move in a sub-scanning direction (an X axis direction in FIG. 2) when the scanning optical system 10 scans the original document. The carriage 15 includes the exposure lamp 15A and a reflector 15B. The exposure lamp 15A is a light emitting body configured to emit light when the scanning optical system 10 scans the original document S. The reflector 15B is a reflection plate configured to reflect, to the original document S, light from the exposure lamp 15A or the LED array 13.

The scanning optical system 10 includes reflection mirrors 17A to 17C, a lens 18, and a CCD sensor 19. The reflection mirrors 17A to 17C are mirrors for making light emitted from the LED array 13 or the exposure lamp 15A and reflected from the original S incident on the CCD sensor 19. The CCD sensor 19 is an image pickup element configured to pickup an image of the original document S, which passes the reflection mirrors 17A to 17C and the lens 18 for adjusting a focus, and convert the image into image data. In this embodiment, the CCD sensor 19 picks up an image at least if the platen cover is open.

The scanning optical system 10 includes an APS sensor 16 (a size detection sensor) configured to detect the size in a main scanning direction (a Y axis direction) of the original document S.

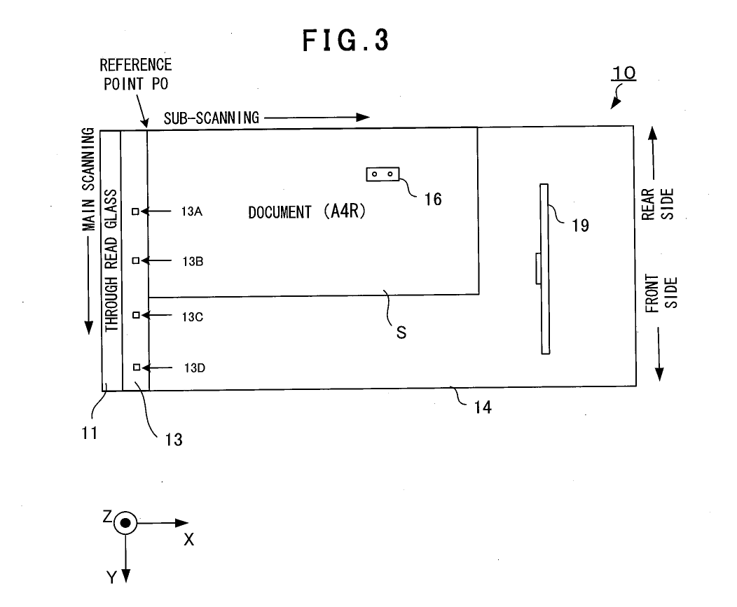

An arrangement example of the LED array 13 and an arrangement example of the original document S are shown in a schematic plan view of FIG. 3. The CCD array 13 includes plural LED elements 13A to 13D arranged in parallel in the main scanning direction (the Y axis direction). The LED elements 13A to 13D are arranged in positions where the LED elements 13A to 13D can distinguish the sizes in the main scanning direction of standardized sheets such as an A3 sheet and an A4 sheet. The example shown in FIG. 3 is an example in which an A4R (A4 landscape) original document S is arranged with a reference point P0 set as an origin. As it is seen from the figure, in the main scanning direction (the Y axis direction), the original document S reaches the positions of the LED elements 13A and 13B but does not reach the positions of the LED elements 13C and 13D. In other words, lights from the LED elements 13A and 13B are irradiated on the original document S through the reflector 15B but the lights from the LED elements 13C and 13D are not irradiated on the original document S.

In the example shown in FIG. 3, four LED elements are arranged. However, the number of LED elements is not limited to this number. One LED element long in the main scanning direction may be arranged. The positions of the LED elements are not limited to the positions in this example.

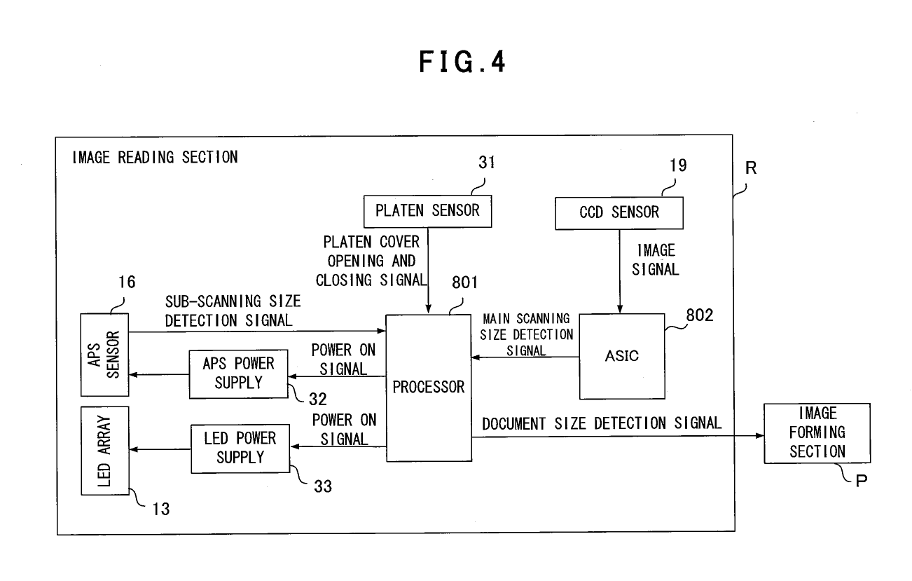

The configuration of the image reading section R is explained. FIG. 4 is a block diagram of a configuration example of the image reading section R.

The image reading section R includes a platen sensor 31 configured to detect opening and closing of the platen cover. The platen cover is integral with the auto document feeder 9. The image reading section R includes an APS power supply 32 configured to control power supply to the APS sensor 16 to be turned on or off and an LED power supply 33 configured to control power supply to the LED array 13 to be turned on or off. The image reading section R includes the LED array 13, the APS sensor 16, the CCD sensor 19, the processor 801, and the ASIC 802.

A method of detecting a document size by the image reading section R is explained with reference to FIG. 4. First, the platen sensor 31 detects whether the platen cover is opened. If the platen cover is opened, the platen sensor 31 outputs a signal (hereinafter referred to as open signal) to the processor 801. If the open signal is input from the platen sensor, the processor 801 outputs a power ON signal to the APS power supply 32 and the LED power supply 33. Electric power is supplied to the LED array 13 and the APS sensor 16. In the first embodiment, the power ON signal is simultaneously output to the APS power supply 32 and the LED power supply 33. The APS sensor 16 and the LED array 13 are simultaneously turned on.

The APS sensor 16 detects the size in the sub-scanning direction of the original document S and outputs a detection signal to the processor 801.

On the other hand, the LED array 13, to which the electric power is supplied, turns on all the LED elements 13A to 13D and irradiates the original document S through the reflector 15B. At this point, any ones of lights from the LED elements 13A to 13D are reflected on the original document S according to the size in the main scanning direction of the original document S. The reflected light from the original document S is made incident on the CCD sensor 19 through the reflection mirrors 17A to 17C and the lens 18 and picked up as an image.

The ASIC 802 analyzes image pickup data (an image signal) acquired by the CCD sensor 19 and outputs a detection signal of the main scanning size to the processor 801. The processor 801 determines, according to the detection signal of the main scanning size and the detection signal of the sub-scanning size from the APS sensor 16, which of document sizes the size of the original document S is. The processor 801 outputs a document size detection signal, which is a determination result, to the image forming section P at the post stage. As a method of determining a document size by the processor 801, for example, a table in which a level value of a detection single of a main scanning size, a level value of a detection signal of a sub-scanning size, and document size information are associated with one another is used.

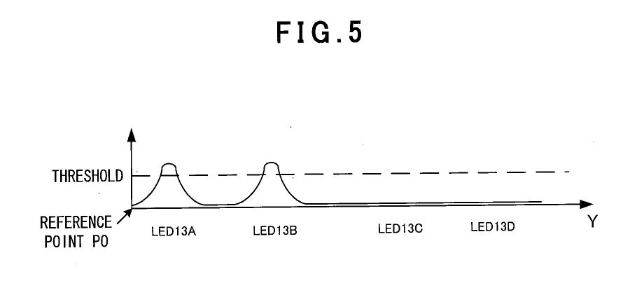

A method of analyzing image pickup data by the ASIC 802 is explained with reference to FIG. 5. FIG. 5 is a graph of an example of luminance information obtained when the A4R sheet shown in FIG. 3 is arranged on the document table glass 14. The abscissa indicates the positions of the LED elements 13A to 13D and the ordinate indicates a luminance value.

The ASIC 802 determines a document size in the main scanning direction by determining whether luminance values in the positions of the LED elements 13A to 13D (pixel positions of image data picked up by the CCD sensor 19) exceed a predetermined threshold. In the example shown in FIG. 5, luminance values of the LED elements 13A and 13B exceed the threshold and luminance values of the LED elements 13C and 13D do not exceed the threshold because there is no reflected light from the original document S. Therefore, in the case of this example, the ASIC 802 determines that an original document having a main scanning size at least equal to or larger than the position of the LED element 13B and smaller than the position of the LED element 13C in terms of a position from the reference point P0 is set. The processor 801 may perform this determination. The ASIC 802 outputs a detection signal of the main scanning size, i.e., in this example, a signal corresponding to the detected LED element 13B to the processor 801.

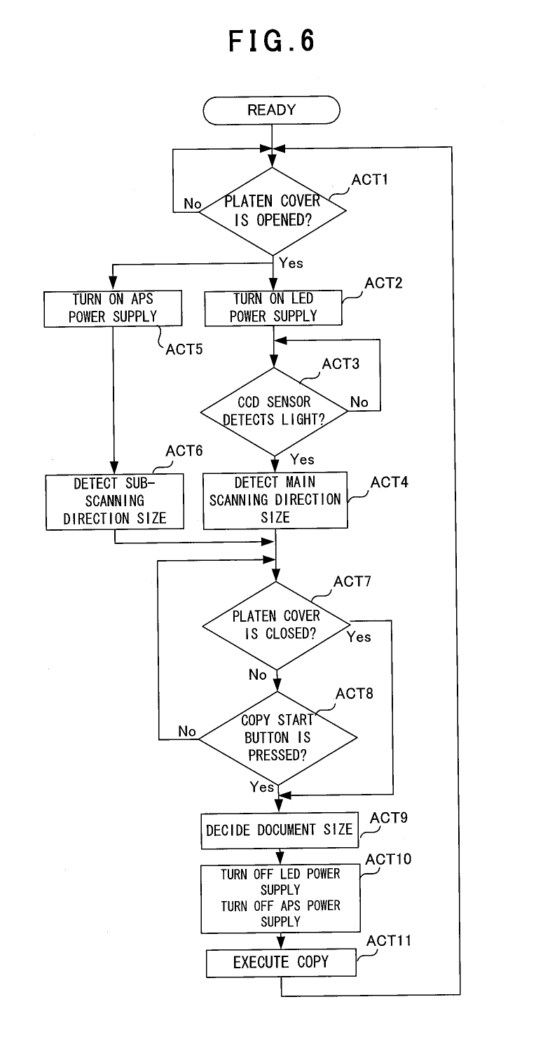

The operation of the image reading section R is explained with reference to a flowchart of FIG. 6.

The processor 801 determines, according to a detection signal from the platen sensor 31, whether the platen cover is opened (ACT 1). If the platen cover is opened (Yes in ACT 1), the processor 801 controls the CCD sensor 19 to be capable of picking up an image and simultaneously turns on the power supplies for the LED array 13 and the APS sensor 16 (ACT 2 and ACT 5). The APS sensor 16, to which electric power is supplied, detects a size in the sub-scanning direction and outputs a detection signal to the processor 801 (ACT 6).

On the other hand, the CCD sensor 19 picks up an image of the original document S that receives light from the LED array 13 (Yes in ACT 3). The ASIC 802 analyzes the image picked up by the CCD sensor 19 and detects a main scanning size of the original document S (ACT 4). At this point, since the platen cover is open, lights from the LED elements that irradiate places where the original document S is not arranged directly pass through the document table glass 14 and are not made incident on the CCD sensor 19. In other words, the lights from the LED elements that irradiate places where the original document S is not arranged are not picked up by the CCD sensor 19 as an image. Luminance values of the pixels do not exceed the threshold. Lights passing through the document table glass 14 are lights from the LED elements having illuminance lower than the illuminance of light from the exposure lamp 15A in the past. The illuminance of the lights is suppressed low according to the transmittance of the document table glass 14 and the reflectance of the reflector 15B. Therefore, a burden on the user's eyes can be reduced.

The processor 801 determines, according to whether a predetermined signal (hereinafter referred to as close signal) is acquired from the platen sensor 31, whether the platen cover is closed (ACT 7). The processor 801 determines whether a copy start button on the control panel 810 is pressed (ACT 8). If the close signal is acquired in ACT 7 (Yes in ACT 7) or if the copy start button is pressed in ACT 8 (Yes in ACT 8), the processor 801 decides a document size and outputs a size in the main scanning direction and a size in the sub-scanning direction to be detected to the image forming section P configured to perform processing in later steps (ACT 9). Thereafter, the processor 801 outputs an OFF signal to the APS power supply 32 and the LED power supply 33. The power supply to the APS sensor 16 and the LED array 13 is stopped (ACT 10). Since the power supply to the APS sensor 16 and the LED array 13 is stopped, LED light is controlled to not affect image reading. The image forming section P performs copy processing in the decided document size (ACT 11). Specifically, the image forming section P forms, in the document size output from the processor 801, an image drawn on the original document S arranged on the document table glass 14 on a sheet.

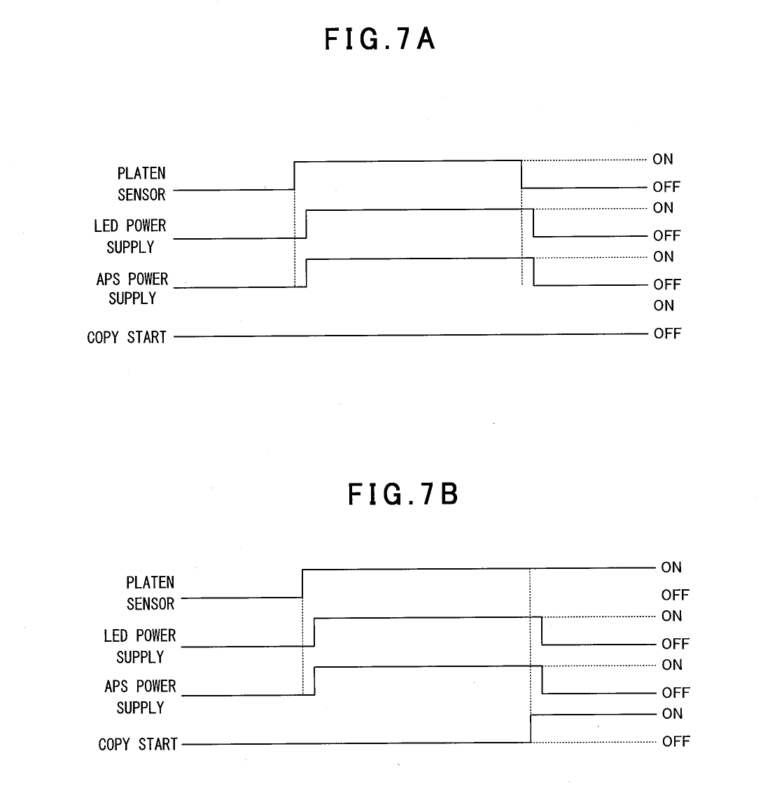

FIG. 7A is a time chart of power on and off performed if the platen cover is opened and closed. In the first embodiment, the power supplies for the LED array 13 and the APS sensor 16 are turned on after the platen sensor 31 is turned on. The power supplies for the LED array 13 and the APS sensor 16 are turned off after the platen sensor 31 is turned off.

FIG. 7B is a time chart of power on and off performed if a copy start button is pressed while the platen cover is not closed. In this case, in the first embodiment, the power supplies for the LED array 13 and the APS sensor 16 are turned on after the platen sensor 31 is turned on. The power supplies for the LED array 13 and the APS sensor 16 are turned off after the copy start button is pressed. In this way, the power supplies for the LEDs and the power supply for the APS sensor are controlled according to the opening and closing of the platen cover and the pressing of the copy start button.

In the image forming apparatus, since a document size can be detected if the platen cover is opened, printing is started earlier than in implementation in the past in which a document size is detected if the platen cover is closed or the copy start button is pressed. Therefore, it is possible to reduce time until completion of printing. It is possible to reduce detection processing for a document size by simultaneously detecting document sizes in the main scanning direction and the sub-scanning direction in parallel as in the first embodiment.

It is possible to suppress electric power lower than electric power in the case of size detection in the main scanning direction performed by using the exposure lamp and the APS sensor in the past.

### Second Embodiment

In the first embodiment, the example in which the APS power supply and the LED power supply are simultaneously turned on at the time of opening of the platen cover and document sizes in the main scanning direction and the sub-scanning direction are simultaneously detected is explained. In a second embodiment, implementation for detecting, after detecting a document size in one of the main scanning direction and the sub-scanning direction, a document size of the other is explained. For example, if a document size can be decided only by size detection in one direction, it is possible that size detection in the other direction does not have to be performed. In the second embodiment, such implementation can be expected.

In the following explanation, implementation for performing, after performing detection of a document size in the main scanning direction, detection of a document size in the sub-scanning direction is explained. However, detection order may be opposite. A document size in the main scanning direction may be detected after a document size in the sub-scanning direction is detected. Since an apparatus configuration and a block configuration are the same as those in the first embodiment, explanation of the apparatus configuration and the block configuration is omitted.

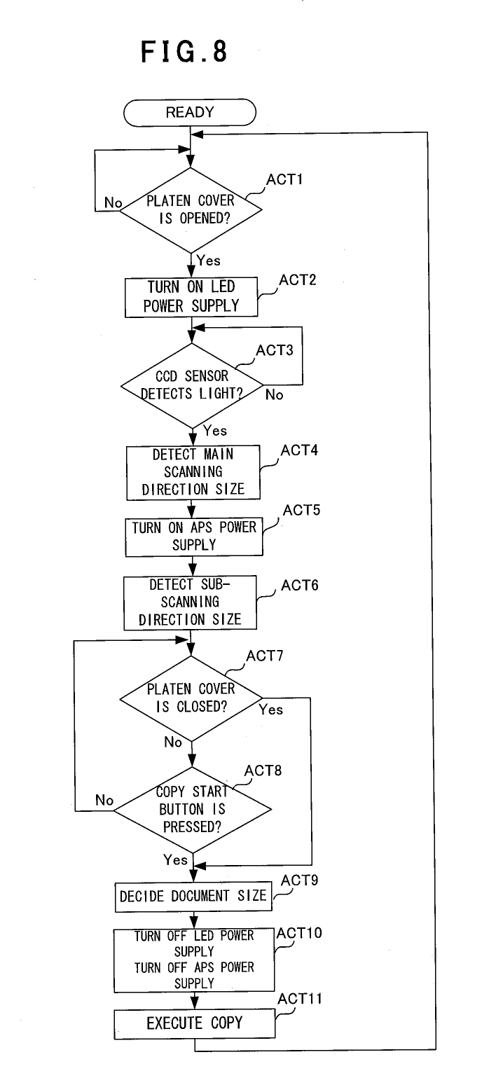

FIG. 8 is a flowchart for explaining an operation example of the image reading section R according to the second embodiment. In the second embodiment, after the power supply for the LED array 13 is turned on (ACT 2), image pickup by the CCD sensor 19 is performed (ACT 3), and detection of a main scanning size by the ASIC 802 is performed (ACT 4), the power supply for the APS sensor 16 is turned on (ACT 5) and detection of a sub-scanning size is performed (ACT 6). The processor 801 performs control of the order of these operations.

Specific contents of the operations and a control flow other than the order of ACT 2 to ACT 6 are the same as those in the first embodiment.

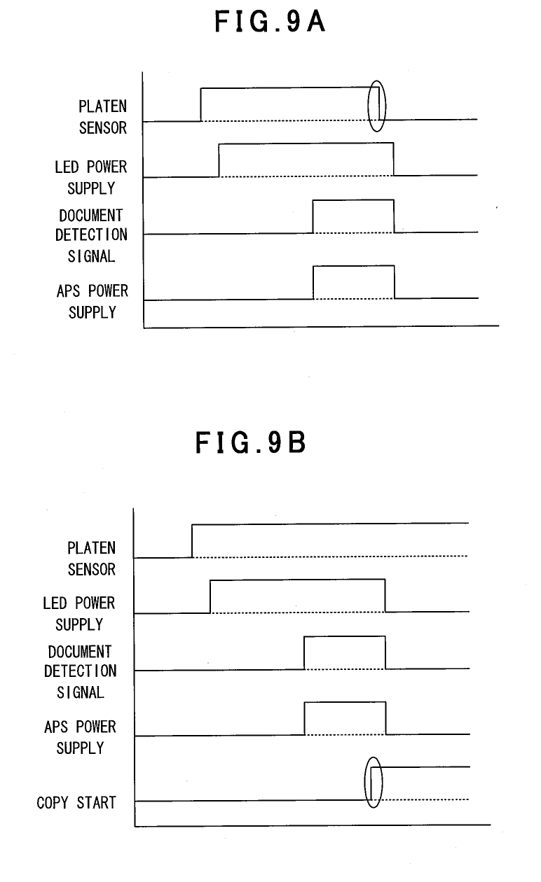

FIG. 9A is a time chart of power on and off performed if the platen cover is opened and closed. FIG. 9B is a time chart of power on and off performed if the copy start button is pressed while the platen cover is not closed. As in the first embodiment, the LED power supply and the APS power supply are controlled according to opening and closing of the platen cover and pressing of the copy start button. In the second embodiment, after the power supply for the LED array 13 is turned on, the APS power supply is turned on and a document detection signal (a signal originated if both sizes in the main scanning direction and the sub-scanning direction are detected) is obtained.

The image reading section R according to the first and second embodiments may be provided as an image reading apparatus. The image reading section R is explained as including the auto document feeder 9. However, a form of the image reading section R is not limited. The image reading section R may include only a cover that does not have a conveying function.

In the first and second embodiments, the light from the LED array 13 is explained as being reflected by the reflector 15B and the reflected light is irradiated on the original document S. However, the light from the LED array 13 may be directly irradiated on the document S.

In the first and second embodiments, the LED array 13 is explained as being arranged in the document scale 12. However, a form of the LED array 13 is not limited. The LED array 13 may be provided in a place other than the document scale 12.

A unit including the processor 801, the ASIC 802, the APS power supply 32, and the LED power supply 33 according to the first and second embodiments may be provided as a control and determining section. The control and determining section turns on, if the platen sensor 31 (a sensor) detects that the platen cover is opened, the power supply for the LED array 13 (a light emitting body) and specifies a pixel having a value exceeding the threshold from an image picked up by the CCD sensor 19 (an image pickup element) to determine the size of an original document arranged on the document table glass 14.

As explained above in detail, according to the technique described in this specification, it is possible to detect a document size in a state in which the platen cover is open. Therefore, it is possible to reduce, by a detection time for a document size, a period until printing processing is actually started after operation for closing the platen cover or operation for printing start is performed. Therefore, it is possible to quickly obtain a sheet on which an image is formed.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image reading apparatus comprising:
a light emitting body configured to emit light at illuminance lower than illuminance in reading an original document;
a sensor configured to detect opening and closing of a cover for pressing, from above, an original document arranged on a document table;
an image pickup element configured to pick up an image of the original document, which is arranged on the document table and on which the light from the light emitting body is irradiated, if the sensor detects that the cover is opened; and
a control and determining section configured to turn on, if the sensor detects that the cover is opened, a power supply for the light emitting body and specify a pixel having a value exceeding a threshold from the image picked up by the image pickup element to determine a size of the original document arranged on the document table.

2. The apparatus according to claim 1, wherein the light emitting body includes plural LED elements.

3. The apparatus according to claim 2, wherein the LED elements are arranged in a position corresponding to a size of a standard sheet.

4. The apparatus according to claim 1, further comprising a size detection sensor configured to detect a size in a sub-scanning direction of the original document, wherein
the light emitting body includes plural light emitting elements arranged in parallel in a main scanning direction of the original direction, and
the control and determining section determines a size in the main scanning direction of the original document using the image picked up by the image pickup element and determines a size in the sub-scanning direction of the original document using the size detection sensor.

5. The apparatus according to claim 4, wherein the control and determining section performs the determination of a size in the main scanning direction and the determination of a size in the sub-scanning direction in parallel.

6. The apparatus according to claim 4, wherein the control and determining section performs, after performing one of the determination of a size in the main scanning direction and the determination of a size in the sub-scanning direction, the other determination.

7. The apparatus according to claim 1, wherein the control and determining section turns off the power supply for the light emitting body if the sensor detects that the cover is opened.

8. The apparatus according to claim 1, wherein the control and determining section turns off the power supply for the light emitting body if a printing start button is pressed.

9. The apparatus according to claim 1, wherein the light emitting body is provided in a document scale that is arranged around the document table and on which any one or both of scales and standard sizes for a user to check a document size are inscribed.

10. The apparatus according to claim 1, further comprising a reflection plate configured to reflect the light from the light emitting body, wherein
the image pickup element picks up an image of the original document on which the light reflected by the reflection plate is irradiated.

11. An image forming apparatus comprising:
a light emitting body configured to emit light at illuminance lower than illuminance in reading an original document;
a sensor configured to detect opening and closing of a cover for pressing, from above, an original document arranged on a document table;
an image pickup element configured to pick up an image of the original document, which is arranged on the document table and on which the light from the light emitting body is irradiated, if the sensor detects that the cover is opened;
a control and determining section configured to turn on, if the sensor detects that the cover is opened, a power supply for the light emitting body and specify a pixel having a value exceeding a threshold from the image picked up by the image pickup element to determine a size of the original document arranged on the document table; and
an image forming section configured to form, in the document size determined by the control and determining section, an image drawn on the original document arranged on the document table on a sheet.

12. The apparatus according to claim 11, wherein the light emitting body includes plural LED elements.

13. The apparatus according to claim 12, wherein the LED elements are arranged in a position corresponding to a size of a standard sheet.

14. The apparatus according to claim 11, further comprising a size detection sensor configured to detect a size in a sub-scanning direction of the original document, wherein
the light emitting body includes plural light emitting elements arranged in parallel in a main scanning direction of the original direction, and
the control and determining section determines a size in the main scanning direction of the original document using the image picked up by the image pickup element and determines a size in the sub-scanning direction of the original document using the size detection sensor.

15. The apparatus according to claim 14, wherein the control and determining section performs the determination of a size in the main scanning direction and the determination of a size in the sub-scanning direction in parallel.

16. The apparatus according to claim 14, wherein the control and determining section performs, after performing one of the determination of a size in the main scanning direction and the determination of a size in the sub-scanning direction, the other determination.

17. The apparatus according to claim 11, wherein the control and determining section turns off the power supply for the light emitting body if the sensor detects that the cover is opened.

18. The apparatus according to claim 11, wherein the control and determining section turns off the power supply for the light emitting body if a printing start button is pressed.

19. The apparatus according to claim 11, wherein the light emitting body is provided in a document scale that is arranged around the document table and on which any one or both of scales and standard sizes for a user to check a document size are inscribed.

20. A size detecting method comprising:
an image reading apparatus detecting opening and closing of a cover for pressing, from above, an original document arranged on a document table;
the image reading apparatus picking up an image of the original document, which is arranged on the document table and on which light from a light emitting body having illuminance lower than illuminance in reading the original document is irradiated, if it is detected that the cover is opened; and
the image reading apparatus turning on, if it is detected that the cover is opened, a power supply for the light emitting body and specifying a pixel having a value exceeding a threshold from the picked-up image to determine a size of the original document arranged on the document table.
